(19) United States
(12) Patent Application Publication
(10) Pub. No.: US 2018/0086187 A1
(43) Pub. Date: Mar. 29, 2018

(54) COWL TOP COVER

(71) Applicant: NIHON PLAST CO., LTD., Shizuoka (JP)

(72) Inventor: Katsumi KURIHARA, Tochigi (JP)

(21) Appl. No.: 15/703,373

(22) Filed: Sep. 13, 2017

(30) Foreign Application Priority Data
Sep. 23, 2016 (JP) 2016-185794

(51) Int. Cl. B60J 10/30; B62D 25/08; B60J 10/70; B60J 10/27

(52) U.S. Cl. CPC B60J 10/30; B60J 10/27; B60J 10/70; B62D 25/081

(57) ABSTRACT

Cowl top cover 1 includes cover main body 9 that covers a portion between windshield 3 and hood 7; and sealing member 11 that is fitted with lock protrusion 19 (first lock protrusion 19A and second lock protrusion 19B) of cover main body 9. Sealing member 11 makes contact with the lower end of windshield 3 to seal a portion between windshield 3 and cover main body 9. A plurality of lock protrusions 19 are intermittently formed along the vehicle width direction, and non-fitting parts 21 where lock protrusion 19 is not provided is formed between each lock protrusion 19.

### CROSS REFERENCE TO RELATED APPLICATIONS

The disclosure of Japanese Patent Application No. 2016-185794 filed on Sep. 23, 2016 including the specification, drawings and abstract is incorporated herein by reference in its entirety.

### TECHNICAL FIELD

The present invention relates to a cowl top cover that is disposed between a hood that covers an engine room and a front window shield panel.

### BACKGROUND ART

Japanese Unexamined Utility Model Registration Application Publication No. H7-17615 discloses a cowl top cover as a windshield sealing structure of an automobile. The cowl top cover includes, on the vehicle body rear side, a sealing-member attaching part for closely attaching a sealing member along the front lower end of the windshield. The sealing-member attaching part has, for example, a fitting structure in which an end is formed in a semi-ellipsoidal protruding shape in cross section, and the sealing member is attached to the sealing-member attaching part by fitting the sealing-member attaching part to the opening edge of the sealing member.

### SUMMARY OF INVENTION

### Technical Problem

Incidentally, the cowl top cover is elongated along the vehicle width direction, and accordingly the sealing-member attaching part and the sealing member are continuously elongated along the same direction. With this configuration, when the sealing member is attached to the sealing-member attaching part from the front side by pressing the sealing member against the sealing-member attaching part, it is necessary to elastically deform the sealing member over the entire length in the vehicle width direction to fit the sealing member to the sealing-member attaching part having a semi-ellipsoidal protruding shape in cross section, and consequently the attaching workability is degraded.

In view of this, an object of the present invention is to improve the attaching workability of a sealing member in a cowl top cover.

### Solution to Problem

A cowl top cover of an embodiment of the present invention includes: a cover main body that covers a portion between a front window shield panel and a hood; and a sealing member that is attached to an end portion of the cover main body on a vehicle rear side direction to seal a portion between the cover main body and the front window shield panel. The cover main body includes a sealing-member attaching part where the sealing member is attached, and the sealing-member attaching part is intermittently formed along a vehicle width direction.

### Advantageous Effects of Invention

According to the present invention, the sealing-member attaching part of the cover main body is intermittently formed along the vehicle width direction. With this configuration, the pushing force for attaching the sealing member to the sealing-member attaching part from the front side can be small in comparison with the case where the sealing-member attaching part is continuously formed along the vehicle width direction, and thus the attaching workability of the sealing member in the cowl top cover is improved.

### BRIEF DESCRIPTION OF DRAWINGS

FIG. 1 is a perspective view of an automobile including a cowl top cover according to an embodiment of the present invention, with the rear part of the automobile omitted;

FIG. 2 is an enlarged sectional view taken along line A-A of FIG. 1;

FIG. 3 is an enlarged sectional view of part B of FIG. 2;

FIG. 4 is a plan view of a state before the sealing member and the cover main body of the cowl top cover of FIG. 1 are coupled to each other;

FIG. 5 is a plan view of a state where the cover main body and the sealing member are coupled to each other in contrast with FIG. 4;

FIG. 6 is a sectional view taken along line C-C of FIG. 5;

FIG. 7 is a sectional view taken along line D-D of FIG. 5; and

FIG. 8 is a sectional view taken along line E-E of FIG. 5.

### DESCRIPTION OF EMBODIMENTS

An embodiment of the present invention is described below with reference to the accompanying drawings.

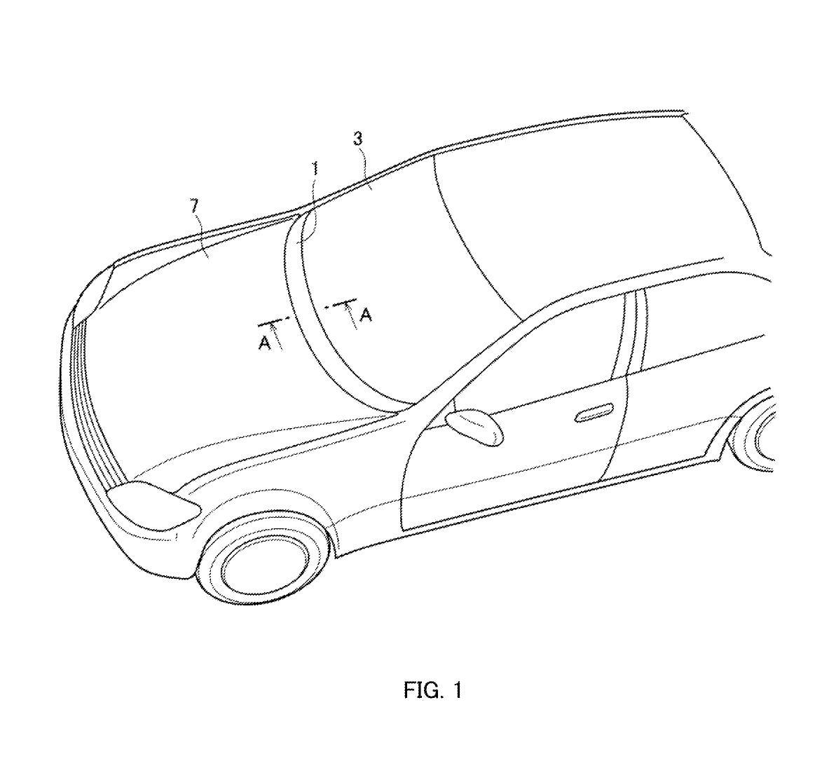

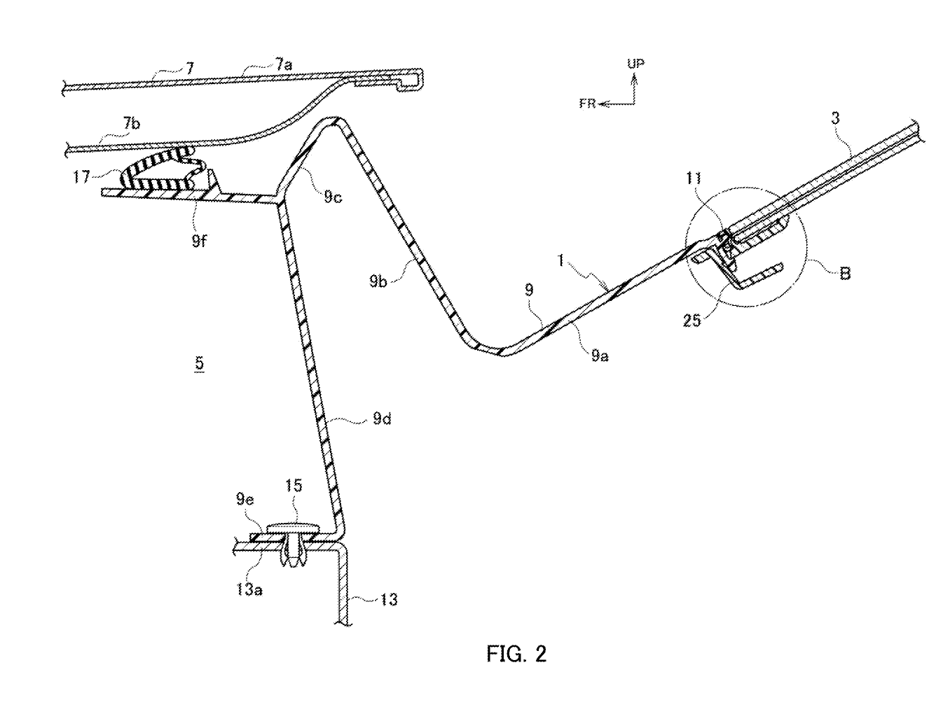

As illustrated in FIG. 1 and FIG. 2, cowl top cover 1 according to the embodiment of the present invention is disposed between windshield 3 that serves as a front window shield panel of an automobile, and hood 7 that covers the upper opening of engine room 5. Hood 7 includes outer panel 7a and inner panel 7b. Cowl top cover 1 is elongated in the vehicle width direction, and the length of cowl top cover 1 in the vehicle width direction is substantially equal to the length of hood 7 in the vehicle width direction. It is to be noted that, in FIG. 2, the direction of FR is the vehicle front side, and the direction of UP is the vehicle upper side.

As illustrated in FIG. 2 that is a sectional view taken along line A-A of FIG. 1, cowl top cover 1 includes cover main body 9 composed of a hard synthetic resin molded article, and sealing member 11 composed of a soft synthetic resin molded article. Cover main body 9 is disposed to cover a portion between windshield 3 and hood 7. Sealing member 11 is attached to an end portion of cover main body 9 on the vehicle rear side, that is, on the right side in FIG. 2, to seal a portion between cover main body 9 and the lower end of windshield 3.

Cover main body 9 includes rear part 9a that is substantially flush with windshield 3, and front portion 9b that is bent at approximately 90 degrees from an end portion of rear part 9a on the side opposite to sealing member 11 and is extended obliquely upward on the vehicle front side. Rear part 9a is extended obliquely downward on the vehicle front side from the rear end portion where sealing member 11 is attached. The front end (upper end) of front portion 9b is located in the proximity of the lower rear end of hood 7.

In cover main body 9, bending part 9c that is bent obliquely downward on the vehicle front side from the front end (upper end) of front portion 9b is formed, and cover main body 9 is branched in two directions, downward and forward, from the lower end of bending part 9c. Downward branch part 9d that is branched downward from the lower end of bending part 9c is tilted slightly to the vehicle rear side toward the lower side. Vehicle body attaching part 9e that is bent from the lower end of downward branch part 9d toward the vehicle front side is formed. Vehicle body attaching part 9e is formed along a substantially horizontal direction, and is fixed with clip 15 to horizontal part 13a of vehicle body panel 13.

Forward branch part 9f branching forward from the lower end of bending part 9c is formed along a substantially horizontal direction, and hood sealing member 17 is fixed by bonding at an upper portion of the leading end side of forward branch part 9f. As illustrated in FIG. 2, when brought into contact with inner panel 7b with hood 7 closed, hood sealing member 17 is elastically deformed to seal a portion between hood 7 and cowl top cover 1.

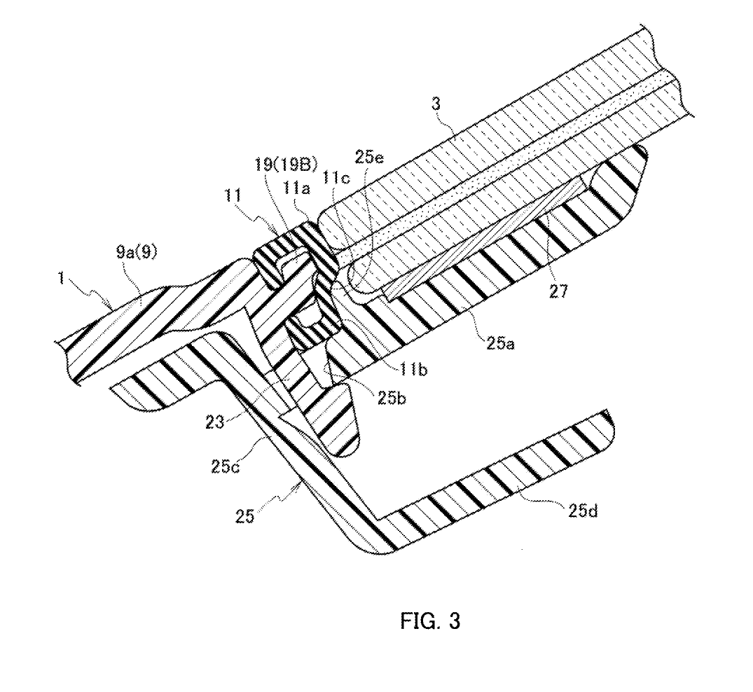

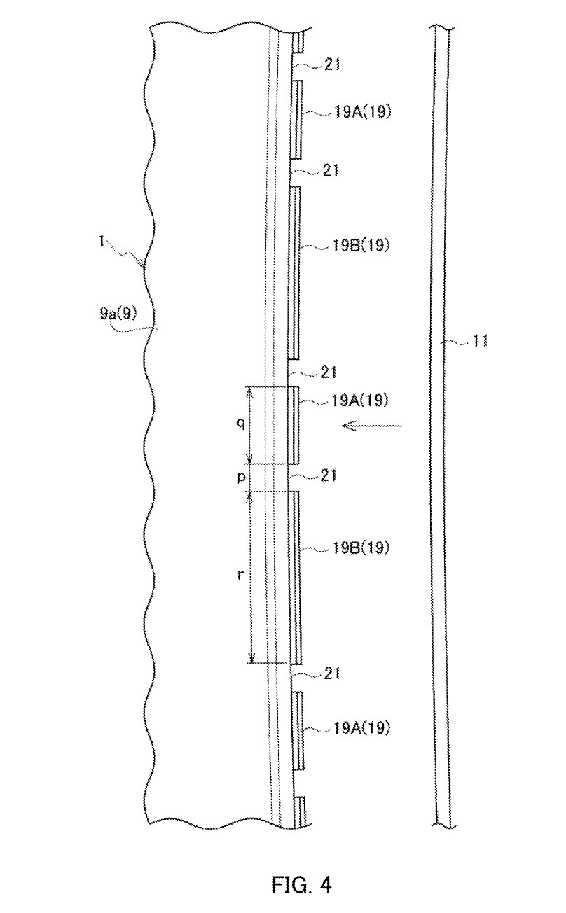

As illustrated in FIG. 3 that is an enlarged view of part B of FIG. 2, lock protrusion 19 is formed at a rear end portion of rear part 9a of cover main body 9. Lock protrusion 19 serves as a sealing-member attaching part for attaching sealing member 11, and as illustrated in FIG. 4, a plurality of lock protrusions 19 are provided along the vehicle width direction (in FIG. 4, the vertical direction) with spaces therebetween. With this configuration, non-fitting parts 21 where lock protrusion 19 is not provided are formed between each lock protrusion 19. Non-fitting part 21 is a part to which sealing member 11 does not fit.

It is to be noted that, in FIG. 4, lock protrusions 19 are provided such that first lock protrusion 19A serving as a first attaching part whose length in the vehicle width direction is short, and second lock protrusion 19B serving as a second attaching part whose length is longer than first lock protrusion 19A are alternately formed along the vehicle width direction. Here, regarding length p of non-fitting part 21 in the vehicle width direction, length q of first lock protrusion 19A in the vehicle width direction, and length r of second lock protrusion 19B in the vehicle width direction, an example ratio of p:q:r is 1:3:6.

As illustrated in FIG. 3, lock claw 23 that is bent at approximately 90 degrees downward from rear part 9a is formed at the rear end portion of rear part 9a of cover main body 9. While lock claw 23 is provided at a position corresponding to second lock protrusion 19B in this example, lock claw 23 may be provided at a position corresponding to first lock protrusion 19A. In each case, a plurality of lock claws 23 are provided along the vehicle width direction at appropriate intervals, and are locked with coupler 25. Coupler 25 is extended along the vehicle width direction by a length substantially equal to the length of cowl top cover 1. Coupler 25 couples cowl top cover 1 and windshield 3.

Coupler 25 includes plate-shaped glass fixing part 25a. Glass fixing part 25a is joined and fixed to the rear surface of windshield 3 at a portion in the proximity of the lower end of windshield 3 with adhesive agent 27. On cowl top cover 1 side of glass fixing part 25a, lock hole 25b through which lock claw 23 is inserted and engaged is provided in accordance with lock claw 23.

Coupler 25 includes upper tilted wall 25c that extends downward approximately in parallel with lock claw 23 on the side opposite to glass fixing part 25a of lock hole 25b. Lower tilted wall 25d that is bent at an angle slightly greater than 90 degrees from the lower end of upper tilted wall 25c, and extended in parallel with glass fixing part 25a is formed so as to cover the lower side of lock hole 25b.

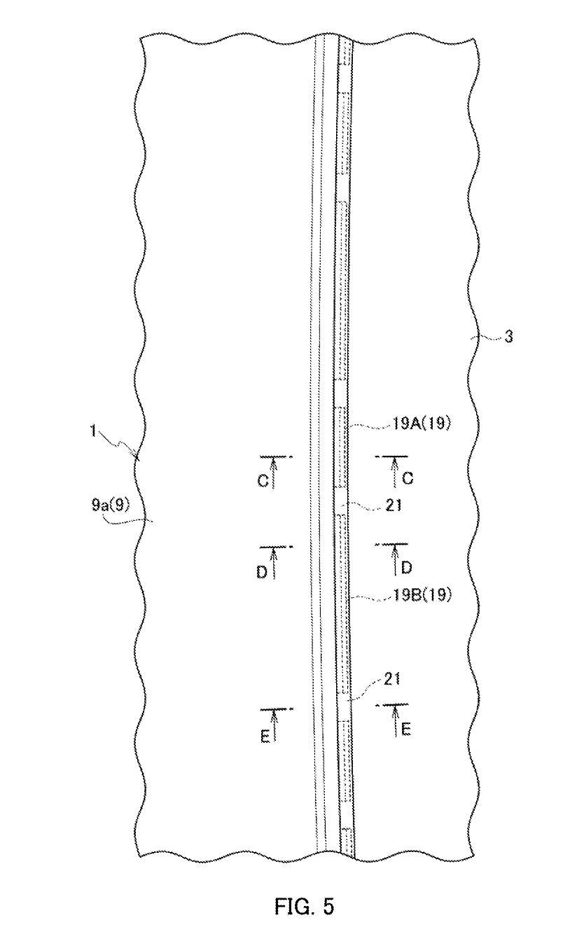

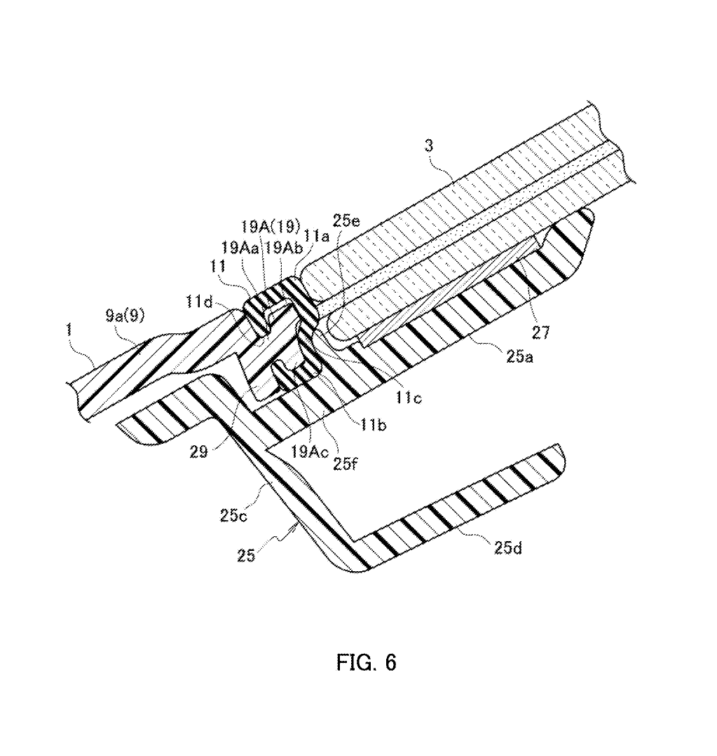

The shapes of lock protrusions 19 are different between first lock protrusion 19A and second lock protrusion 19B. First lock protrusion 19A is illustrated in FIG. 6 that is a sectional view taken along line C-C of FIG. 5. First lock protrusion 19A includes base part 19Aa protruding from rear part 9a of cover main body 9 toward windshield 3 and a pair of lock parts 19Ab and 19Ac respectively protruding upward and downward from base part 19Aa. It is to be noted that FIG. 6 is a sectional view of a portion where lock claw 23 illustrated in FIG. 3 is not provided, but downward protrusion 29 is formed in place of lock claw 23.

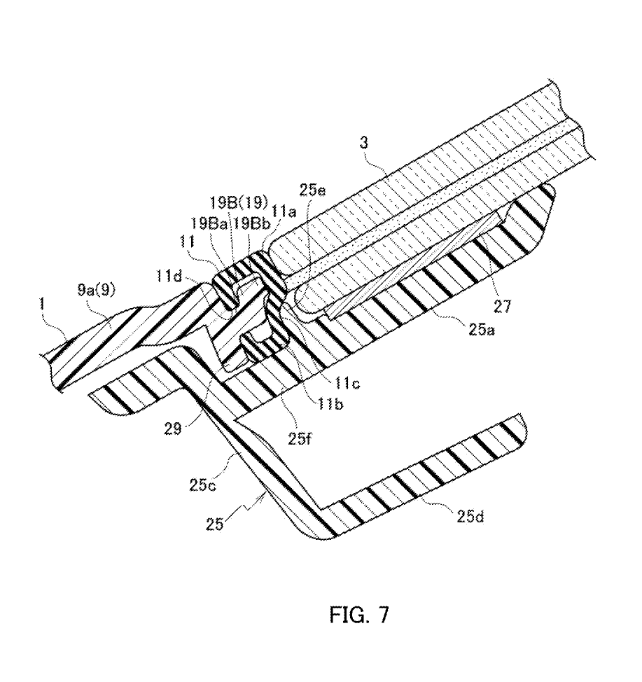

Second lock protrusion 19B is illustrated in FIG. 7 that is a sectional view taken along line D-D of FIG. 5. Second lock protrusion 19B includes base part 19Ba protruding from rear part 9a of cover main body 9 toward windshield 3 and lock part 19Bb protruding upward from base part 19Ba, and the lock part protruding downward is not provided in second lock protrusion 19B. It is to be noted that FIG. 7 is a sectional view of a portion where lock claw 23 illustrated in FIG. 3 is not provided, but downward protrusion 29 is formed in place of lock claw 23 as with FIG. 6.

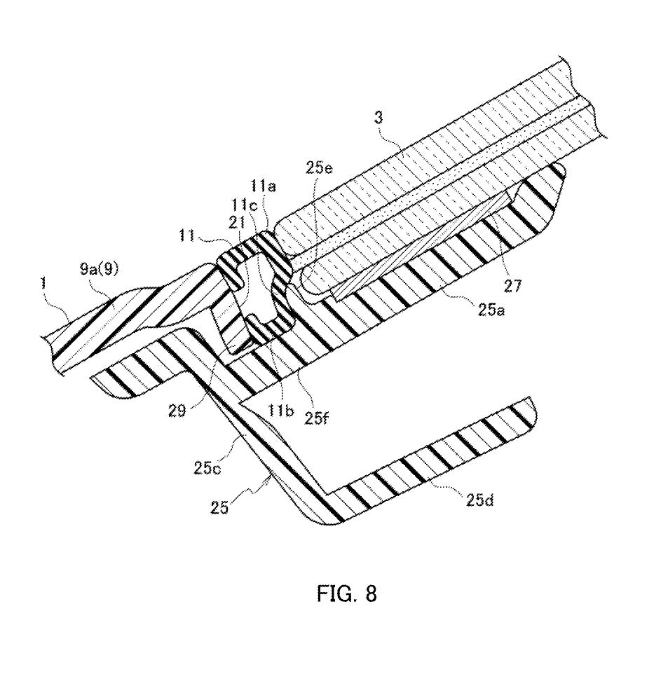

FIG. 8 is a sectional view taken along line E-E of FIG. 5 of a portion corresponding to non-fitting part 21, and the base part, the lock part protruding upward and the lock part protruding downward illustrated in FIG. 6 are not provided therein. Accordingly, at non-fitting part 21, sealing member 11 is only in contact with the rear end surface of cover main body 9 without being fitted with cover main body 9.

As illustrated in FIG. 3 and FIG. 6 to FIG. 8, sealing member 11 has a C-like shape in cross section over the entire length in the vehicle width direction. Sealing member 11 includes upper fitting part 11a where lock part 19Ab located at an upper portion of first lock protrusion 19A illustrated in FIG. 6 and lock part 19Bb of second lock protrusion 19B illustrated in FIG. 7 are fitted at different positions in the vehicle width direction. Sealing member 11 further includes lower fitting part 11b where lock part 19Ac located at a lower portion of first lock protrusion 19A is fitted. As illustrated in FIG. 7, lower fitting part 11b is not fitted with second lock protrusion 19B.

As illustrated in FIG. 6, in first lock protrusion 19A, the cross-sectional shape of lock part 19Ab located on the upper side is larger than the cross-sectional shape of lock part 19Ac located on the lower side. For such a configuration, in sealing member 11, the cross-sectional shape of upper fitting part 11a that is fitted with lock part 19Ab is larger than the cross-sectional shape of lower fitting part 11b that is fitted with lock part 19Ac.

With sealing member 11 fitted with lock protrusion 19 (first lock protrusion 19A and second lock protrusion 19B), the rear end surface of upper fitting part 11a makes contact with the lower end of windshield 3. Tilted part 11c that is tilted in a direction away from windshield 3 is formed between upper fitting part 11a and lower fitting part 11b of sealing member 11. Pressing protrusion 25e provided in coupler 25 is in contact with the rear end surface of tilted part 11c and lower fitting part 11b.

Pressing protrusion 25e of coupler 25 is located in a region around windshield 3 and protrudes upward from the top surface of intermediate part 25f between glass fixing part 25a and lock hole 25b. Pressing protrusion 25e is formed over the entire length in the vehicle width direction. The lower end of sealing member 11 makes contact with the top surface of intermediate part 25f, and downward protrusion 29 of cover main body 9 is separated from intermediate part 25f.

When sealing member 11 is fitted with first lock protrusion 19A as illustrated in FIG. 6, upper and lower lock parts 19Ab and 19Ac are covered and housed in the internal space, and base part 19Aa is inserted in opening 11d of the C-like shape. On the other hand, when sealing member 11 is fitted with second lock protrusion 19B as illustrated in FIG. 7, lock part 19Bb is covered and housed in the internal space, and base part 19Ba is inserted in the opening 11d of the C-like shape.

As described above, with cowl top cover 1 of the present embodiment, lock protrusions 19 serving as the sealing-member attaching part of cover main body 9 are intermittently formed along the vehicle width direction. With this configuration, the pushing force for pushing and attaching sealing member 11 from the front side of lock protrusion 19 can be smaller than that for the configuration in which lock protrusion 19 is continuously formed along the vehicle width direction. Accordingly, the operation of attaching sealing member 11 to cover main body 9 is significantly eased and the attaching workability is improved. Also, the improvement in attaching workability contributes to improvement in mounting precision.

According to the present embodiment, lock protrusion 19 of cover main body 9 includes base parts 19Aa and 19Ba protruding toward windshield 3 from cover main body 9, and lock parts 19Ab, 19Ac and 19Bb protruding upward or downward, or both, from base parts 19Aa and 19Ba.

In this case, as first lock protrusion 19A illustrated in FIG. 6, sealing member 11 is fitted with a pair of lock parts 19Ab and 19Ac protruding upward and downward, and thus the attaching state is stabilized even when lock protrusions 19 are intermittently formed. On the other hand, as second lock protrusion 19B illustrated in FIG. 7, sealing member 11 is fitted with only lock part 19Bb protruding upward, and thus the operation of attaching sealing member 11 to cover main body 9 is further eased.

That is, in the present embodiment, the sealing-member attaching part of cover main body 9 includes the first attaching part including a pair of upper and lower lock parts 19Ab and 19Ac, and the second attaching part including only lock part 19Bb protruding upward. With this configuration, cowl top cover 1 of the present embodiment can stabilize the attaching state with the first attaching part, and also can ease the attaching operation with the second attaching part.

In addition, since the first attaching part and the second attaching part are alternately formed along the vehicle width direction, the attaching state can be further stabilized in comparison with a configuration in which the first attaching part and the second attaching part are unevenly formed, for example.

Sealing member 11 of the present embodiment has a C-like shape in cross section, and includes upper fitting part 11a that is fitted with upper lock part 19Ab, and lower fitting part 11b that is fitted with lower lock part 19Ac. The cross-sectional shape of lower fitting part 11b is smaller than that of upper fitting part 11a.

With this configuration, at the time when upper fitting part 11a of sealing member 11 is fitted to upper lock part 19Ab, lower fitting part 11b is elastically deformed such that lower fitting part 11b is easily bent with respect to upper fitting part 11a. As a result, lower fitting part 11b of sealing member 11 can be easily fitted with lower lock part 19Ac.

While the invention made by the present inventor has been specifically described based on the preferred embodiments, it is not intended to limit the present invention to the above-mentioned preferred embodiments but the present invention may be further modified within the scope and spirit thereof.

For example, in the above-mentioned embodiment, regarding length p of non-fitting part 21 in the vehicle width direction, length q of first lock protrusion 19A in the vehicle width direction, and length r of second lock protrusion 19B in the vehicle width direction in cover main body 9, the ratio p:q:r is exemplified as 1:3:6. However, by appropriately changing the ratio p:q:r, the stability of the attaching state of sealing member 11 to cover main body 9, and the ease of the operation of attaching sealing member 11 to cover main body 9 can be easily adjusted.

For example, the attaching state is further stabilized by increasing the ratio of length q of first lock protrusion 19A to length r of second lock protrusion 19B (for example, by increasing length q of first lock protrusion 19A to a length greater than length r of second lock protrusion 19B). Conversely, the attaching operation is further eased by increasing the ratio of length r of second lock protrusion 19B to length q of first lock protrusion 19A (for example, by increasing length r of second lock protrusion 19B to a length greater than length q of first lock protrusion 19A). In addition, the attaching operation is further eased by increasing the number of non-fitting parts 21, while the attaching state is further stabilized by reducing the number of non-fitting parts 21.

While second lock protrusion 19B illustrated in FIG. 7 includes lock part 19Bb protruding upward in the above-mentioned embodiment, the lock part protruding downward may be provided in place of lock part 19Bb protruding upward, as lock part 19Ac of FIG. 6.

In addition, lock protrusion 19 may have a configuration in which the portion provided with second lock protrusion 19B is first lock protrusion 19A such that first lock protrusion 19A is provided in its entirety.

### REFERENCE SIGNS LIST

1 Cowl top cover
3 Windshield (front window shield panel)
7 Hood
9 Cover main body of cowl top cover
11 Sealing member of cowl top cover
11a Upper fitting part of sealing member
11b Lower fitting part of sealing member
19 Lock protrusion of cover main body (sealing-member attaching part)
19A First lock protrusion of cover main body (first attaching part, sealing-member attaching part)
19B Second lock protrusion of cover main body (second attaching part, sealing-member attaching part)
19Aa, 19Ba Base part of lock protrusion
19Ab, 19Ac, 19Ba Lock part of lock protrusion

1. A cowl top cover comprising:
a cover main body that covers a portion between a front window shield panel and a hood; and
a sealing member that is attached to an end portion of the cover main body on a vehicle rear side direction to seal a portion between the cover main body and the front window shield panel,
wherein the cover main body includes a sealing-member attaching part where the sealing member is attached, and the sealing-member attaching part is intermittently formed along a vehicle width direction.

2. The cowl top cover according to claim 1, wherein the sealing-member attaching part includes a base part protruding from the cover main body toward the front window shield panel, and a lock part protruding upward and/or a lock part protruding downward from the base part.

3. The cowl top cover according to claim 2, wherein:
the sealing-member attaching part includes a pair of lock parts that respectively protrude upward and downward from the base part; and
the sealing member has a C-like shape in cross section, and includes:
an upper fitting part that is fitted with one of the pair of lock parts which protrudes upward, and
a lower fitting part that has a cross-sectional shape smaller than a cross-sectional shape of the upper fitting part, and is fitted with the other one of the pair of lock parts which protrudes downward.

4. The cowl top cover according to claim 2, wherein a first attaching part and a second attaching part are provided in the sealing-member attaching part,
the first attaching part including:
a base part protruding from the cover main body toward the front window shield panel, and
a pair of lock parts that respectively protrude upward and downward from the base part, and
the second attaching part including:
a base part protruding from the cover main body toward the front window shield panel, and
a lock part protruding upward or a lock part protruding downward from the base part.

5. The cowl top cover according to claim 4, wherein a length of the first attaching part in the vehicle width direction is greater than a length of the second attaching part in the vehicle width direction.

6. The cowl top cover according to claim 4, wherein a length of the second attaching part in the vehicle width direction is greater than a length of the first attaching part in the vehicle width direction.

7. The cowl top cover according to claim 4, wherein the first attaching part and the second attaching part are alternately formed along the vehicle width direction.
